(19) United States
(12) Patent Application Publication
(10) Pub. No.: US 2003/0018975 A1
(43) Pub. Date: Jan. 23, 2003

(54) Method and system for wireless audio and video monitoring

(76) Inventor: Christopher J. Stone, Newtown, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/908,392

(22) Filed: Jul. 18, 2001

(51) Int. Cl. H04N 7/18

(52) U.S. Cl. 725/105; 348/143

(57) ABSTRACT

The present invention employs a local base station including a transceiver that is arranged to receive wireless image and audio signals from remote capture devices. The transceiver is also arranged to transmit wireless information signals to remote display and control devices such as Internet appliances (IAs) and other information devices having wireless interfaces such as mobile phones, personal digital assistants (“PDAs”), pagers, cameras and set-top boxes. The transmitted information signal may be configured by a user or service provider, by interaction with the base station, capture device or remote device to so that selected content of the received signals is played or displayed on the remote devices. The selected content may also be played or displayed using devices, such as televisions and sound systems, that are locally coupled to the base station.

### BACKGROUND OF THE INVENTION

The present invention relates generally to wireless communications, and more particularly to a method and system for wireless audio and video monitoring.

### SUMMARY OF THE INVENTION

The present invention employs a local base station including a transceiver that is arranged to receive wireless image and audio signals from remote capture devices. The transceiver is also arranged to transmit wireless information signals to remote display and control devices such as Internet appliances (IAs) and other information devices having wireless interfaces such as mobile phones, personal digital assistants (“PDAs”), pagers, cameras and set-top boxes. The transmitted information signal may be configured by a user or service provider, by interaction with the base station, capture device or remote device to so that selected content of the received signals is played or displayed on the remote devices. The selected content may also be played or displayed using devices, such as televisions and sound systems, that are locally coupled to the base station.

In other arrangements of the invention, the base station additionally incorporates the features and functions of a media controller (i.e., a “set-top” box) including a media port for receiving analog and digital television and digital broadband signals (such as TCP/IP signals used to transmit Internet content), via a coupled broadband cable or DSL line, and an output port for transmitting analog or digital audio, video and graphic signals to locally coupled devices such as televisions, personal computers, and other home entertainment equipment. The base station is user-configurable so that selected content controlled by the media controller may be transmitted separately, or combined with selected content from the received wireless signals and transmitted, via the wireless transceiver, to the remote device.

Another arrangement of the invention includes a set-top box that is configured with an interface to a wireless transceiver. A separate, discrete wireless transceiver may be coupled to the interface to allow image and audio signals captured from remote capture devices to be received by the set-top box and transmitted to remote information devices.

In an illustrative embodiment of the invention, the base station is locally coupled to a home entertainment system including a television monitor and sound system. The base station is configured to transmit cable television programming and Internet content (including graphical and multimedia content comprising video and audio) to the home entertainment system according to user-selectable criteria.

A camera is remotely located in a designated area, such as a baby's room. The camera includes a digital wireless transmitter complying with a well known wireless protocol, be it a variant of the IEEE-802.11 protocol, the IEEE-802.15 protocol, the IEEE-802.16 protocol, the HomeRF protocol, Bluetooth, or any other such protocol that is well known to the art, for wireless transmission of images captured by the camera, in either still or motion formats (i.e., video), to the wireless transceiver in the base station. An information device, such as an IA, or web-accessible PDA or mobile phone is arranged to receive and display/play user-selectable content from the multiple available sources at the base station (including the television programming, Internet content, or images and audio capture by the camera), either singularly or in combination, via wireless transmission from the base station.

Accordingly, the information device may, in accordance with user preference or command, play images and sounds of the baby's room that are captured by the camera and transmitted to the information device via the base station over the wireless links. The images may, for example, be configured in a separate “window” as a sub-display of the total image display of the information device (commonly referred to as a “picture-in-picture” arrangement), or may be configured to occupy the total display area. Thus, a parent may monitor a sleeping baby in a remote location while simultaneously interacting with other media content such as browsing the world wide web, sending and receiving email, or watching a television program on the information device.

In addition, the captured images may be configured, according to user preferences or commands, to switch with other media content on time-sequenced basis (e.g., the window containing camera images comes to the front of the display every minute for several seconds), or a context-sensitive basis (e.g., the window comes to front when a commercial break in a television program is encountered, or a period of inactivity in web-browsing occurs, but otherwise stays in the “background”), or an event-sensitive basis (the window comes to the front if motion or sound beyond a pre-set threshold is reached), or a combination thereof. The captured audio stream may be similarly configured for priority for the user's attention according to user preferences or commands.

The locally coupled television and sound system may also be arranged, in accordance with the invention, to display and play the wireless image and audio signal received from the remote camera, under control of the base station. As with the information device described above, the user may select how the content from the camera is given priority with respect to television or Internet content on the television monitor or sound system. Thus, the signal presented to the television and sound system, at a given time, may be from a single source or be a composite signal from multiple sources in analog or digital formats.

In other illustrative embodiments of the invention, the information device may be arranged to function as a single-interface controller for a wide variety of devices, including consumer electronics such as VCRs and CD, DVD, MP3, audio cassette, mini-disc, and laser disc players and changers which may be integrated within the base station or be arranged as physically discrete, separate components.

Advantageously, the information device may download macro commands and profile data from a remote source such as controller at a head-end of a service provider. Such macro commands and profile data is specific to the electronic devices employed by the user (i.e., the macros and profile data are device-dependent), and allows the user to set-up, configure, operate and program the electronic devices using a single consistent interface that is provided by the information device. Thus a single interface may be used for a wide variety of electronic devices (i.e., the interface and menu structure employed by the information device is device-independent). Thus, by using a single information device, the user can wirelessly set-up, configure, operate and program all of the user's home electronics at a remote location without needing to consult with operator manuals or deal with complex sequences of button pushes that may vary considerably from device to device.

### BRIEF DESCRIPTION OF THE DRAWING

FIG. 1 depicts a diagram of an arrangement, in accordance with the invention, including a local base station, a remote camera with wireless communication capability, and a remote information device with wireless communication capability.

FIG. 2 shows functional modules of the base station including a set-top box, wireless transceiver, and signal processing modules.

FIG. 3 shows an illustrative embodiment of the base station of FIG. 1 where a wireless transceiver is arranged as a separate component and the base station includes a wireless transceiver interface.

FIG. 4 shows an illustrative embodiment of a base station including a set-top box, wireless transceiver, signal processing, media player/controller, and broadcast receiver modules.

### DETAILED DESCRIPTION

At this point, it is worthy to note that any reference herein to “one embodiment” or “an embodiment” means that a particular feature, structure, or characteristic described in connection with the embodiment is included in at least one embodiment of the invention. The appearances of the phrase “in one embodiment” in various places herein are not necessarily all referring to the same embodiment. In addition, the use of the term “including” in the description should be understood to mean that the articles or elements specified after the term are merely exemplary, and that the limitations on the invention are only contained in the claims that follow.

Referring now to FIG. 1, there is shown a simplified block diagram of an illustrative embodiment of the invention, including a local base station 100, a remote camera with wireless communication capability 140, and a remote information device with wireless communication capability 150. Base station 100 is locally coupled to television 130.

It is noted that the terms “local” and “remote” are used here merely to facilitate the description of the relative locations of components and devices (collectively, “devices”) with respect to one another. In addition these terms further describe a communications path among such devices where local devices communicate via a hard wire connection, and remote devices use a wireless connection. Thus, the remote devices 140 and 150 may be located within a single room of a home or office with the base station 100, or each device may be located in physically diverse areas and separated at considerable distances, depending upon the requirements of the specific application of the invention. Design factors such as powering configuration, transceiver transmission and reception characteristics, and device packaging, to name a few, would be selected accordingly.

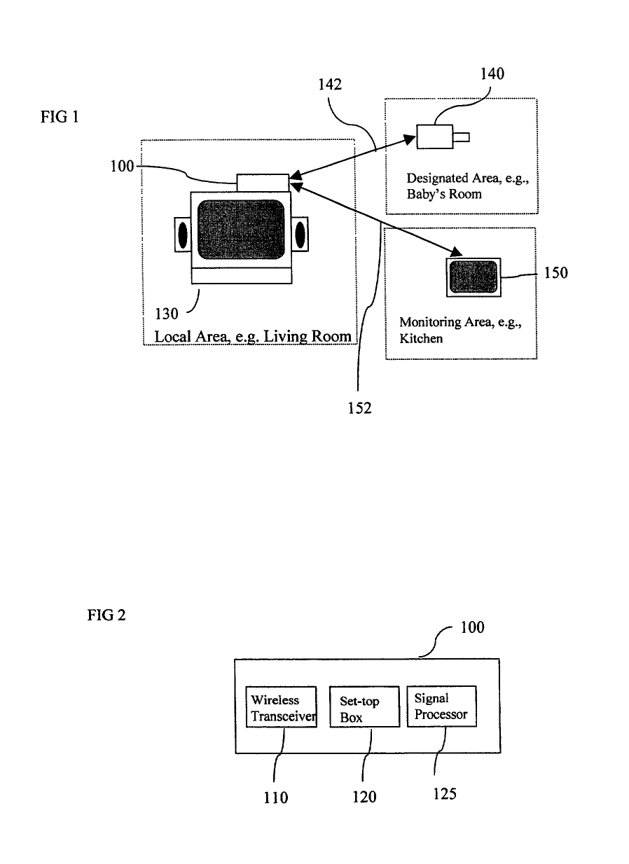

FIG. 2 shows that base station 100 includes a transceiver 110, a set-top box module 120 and a signal processor 125. In some applications of the invention, it may be desirable to integrate these components within a common chassis or enclosure. In such cases, packaging convenience or the elimination of redundant elements such as power supplies and other typical electronic circuitry (not shown in FIG. 2) may be advantageous. FIG. 2 shows an example of such integration within a common chassis or enclosure where the integrated device is referred to as base station 100.

Set-top box module 120 is configured with typical media access and control functions that are utilized, for example, with digital cable and satellite program providers. Such functions include, for example, video-on-demand, t-commerce, personal video recording, interactive television programming, Internet access, gaming, and voice and video telephony, as well television program offerings.

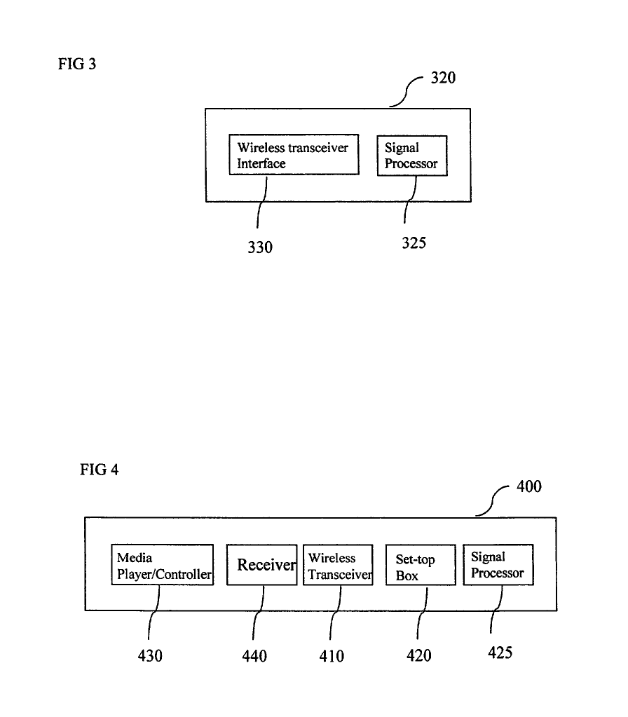

FIG. 3 shows an illustrative embodiment where certain components shown in FIG. 2 are not integrated within a single enclosure or chassis. Specifically, as shown in FIG. 3, wireless transceiver 110 is arranged as a separate and discrete component from set-top box 320. It may be desirable, in some applications of the invention, to provide a set-top box having a wireless transceiver interface and a separate, discrete wireless transceiver so that users may employ a modular approach to enabling wireless features and functions, or may upgrade to such features and functions if services are limited in initial availability, for example.

The utilization of a common chassis/enclosure approach, or an approach using separate/discrete components will depend upon the requirements of the particular application of the invention. In the detailed description of the invention that follows, accordingly, when wireless transceiver 110 is denoted, it should be understood that such description (and concomitant features and advantages) applies equally to wireless transceivers that are integrated (as shown in FIG. 2), and wireless transceivers that are not integrated (as shown in FIG. 3), with other components forming the inventive arrangement.

FIG. 3 shows an arrangement where existing or known electronic devices, such as set-top boxes, may be adapted with a wireless transceiver interface 330 to realize the benefits of the invention. While a set-top box 320 having a wireless transceiver interface 330 is shown in FIG. 3, it is noted that the inclusion of a similar interface to other devices may also be advantageous. For example, such other devices may include consumer electronics like televisions, home theaters electronics, security systems, radios, game consoles, home network controllers, personal computers, appliances, and the like.

Set-top box 320 is configured in a similar manner as set-top box module 120 (FIG. 2) and includes the same features and functions. Set-top box 320 further includes a processor 325, as shown in FIG. 3, which includes the same features and functions as processor 125 (FIG. 2). Signal processor 325, while shown in FIG. 3 as a discrete device, may be combined with other processors that are typically utilized in most set-top box arrangements.

Wireless transceiver interface 330 includes both communications ports and processor capability to allow set-top box 320, when coupled to a separate wireless transceiver (not shown in FIG. 3 but having functions similar to wireless transceiver 110 in FIG. 2), to perform the wireless communication and media content manipulation/control/presentation functions described in more detail below. The communications port is arranged to allow bi-directional communications between the set-top box 320 and the wireless transceiver, using for example, a USB wired connection, or IEEE-802.3 Ethernet-type connection.

Returning to FIG. 1, base station 100 is locally coupled to a conventional television 130 having video and audio capability using either digital or analog formats. While a television is shown in FIG. 1, other electronic equipment having display devices such as personal computers, may be advantageously used in some applications of the invention.

The television 130 may, for example, be part of a home entertainment system in a living room of a house. Such home entertainment system may include a discrete sound system that is separate from the television 130. In either case (integrated or separate video and audio functionality), base station 100 is arranged to supply visual and/or audio signals that are displayed and played using an individual or a collection of devices in the local area, like a living room. Television 130 in FIG. 1 represents all such individual or collected devices.

As noted above, the local connection between base station 100 and television 130 is effectuated using a hard wire connection, for example, using the analog antenna or co-axial cable/CATV inputs that are typical with many televisions. In such cases, the signal from base station 100 to television 130 may be formatted in ATSC format. Alternatively, a wired connection utilizing a digital format may be used, including Universal Serial Bus (“USB”), Digital Video Interface (“DVI”), or IEEE-1394(i.e., “Firewire”) standards, for example.

Base station 100 incorporates a wireless transceiver 110 for receiving wireless signals from remote capture devices, including camera 140. In this illustrative embodiment of the invention, a digital wireless transceiver is employed that complies with the IEEE-802.11 standard having a nominal transfer rate of up to 11 Mb/s (megabits per second) in the 2.4 GHz RF band. However, in other applications, other schemes (both analog and digital) may be advantageously employed.

Camera 140 is configured to capture video and audio in an area of interest, such as a room (or a selected portion of the room) in a house where a baby is napping. Alternatively, other devices capable of capturing information from a designated area may also be used in other applications. For example, it may be desirable to capture audio only, or still (rather than moving) images. In such cases, an audio microphone, or digital camera, respectively, may be used.

Camera 140 is equipped with a wireless transmitter. In some applications of the invention, a digital wireless transmitter provides the best balance between power consumption and transmission performance, although analog schemes may also be used. In this illustrative embodiment, a digital wireless transmitter complying with the IEEE-802.11 standard is utilized.

The remote information device 150 is a device that is capable of displaying images or playing audio. Information device 150 may optionally include controls to enable a user to control or manipulate characteristics of the displayed image or played audio such display size, audio volume, and the like. As noted above, examples of information devices that may be utilized in the inventive arrangement include PDAs, IAs, cameras, pagers, cameras and set-top boxes.

Information device 150 is equipped with a wireless receiver. In applications where bi-directional communications is desired or required, information device 150 would incorporate a wireless transmitter to facilitate, for example, control and information signals to be transmitted from the device. In this illustrative embodiment of the invention, information device 150 includes a digital wireless transceiver having both transmitter and receiver functions comporting with the IEEE-802.11 standard.

In operation, the captured scene from camera 140 is transmitted to base station 100 in a IEEE-802.11 compliant digital wireless transmission stream (shown in FIG. 1 by reference number 142). The base station 100 may relay the received signal to information device 150 using the transmitter portion of transceiver 110 over wireless link 152 in FIG. 1, or the received signal may be processed using a signal processor 125 in base station 150. The processed signal may then be transmitted to information device 150 from transceiver 110 over wireless link 152. The signal processor 125 is optionally utilized in some applications of the invention to allow the signal from the camera 140 to be manipulated or controlled in a variety of manners to effect characteristics such as image size and resolution, frame rate, color depth of the transmitted signal.

Signal compression and other techniques may also be performed by signal processor 125. For example, signal processor 125 may be used to encode the image and audio stream received from camera 140 into an MPEG-2 (Moving Pictures Expert Group, Phase 2) compliant stream. Content from the input sources to base station 100, for example television programming and Internet content, may also be encoded along with the video and audio content from camera 140 into a single synchronous MPEG-2 encoded stream. The MPEG-2 encoded stream may be sent via base station 100 over wired and/or wireless links, i.e., to the coupled television 130 or to information device 150 where the stream would be decoded and played.

Camera 140 may also be equipped with signal coding capability (by using, for example, an MPEG-2 encoder). Accordingly, in addition to encoding functionality, signal processor 125 may be arranged to perform decoding functions (that is, signal processor 125 may optionally include encoding, decoding, or codec functionality). Thus, in some applications of the invention base station 100 may take an encoded signal from a remote source, perform a local decoding operation, and then transmit the decoded signal to the locally coupled television 130, the information device 150, or some other device on either wired or wireless links. Alternatively, base station 100 may take an un-encoded signal from a source (such as television programming and Internet content from set-top box module 120 or the video and audio stream from camera 140) and encode such signal into a compressed bit stream such an MPEG-2 compliant stream. In some applications additional processing of the received signal may be desirable, for example line doubling (or other image enhancing) or audio processing to create spatial or tonal effects, prior to or through the encoding process.

Signal processor 125 may use processing parameters that are determined using several arrangements including pre-programmed (i.e., fixed) processing parameters, adjustable processing parameters, or a combination of fixed and adjustable parameters. Processing parameters may be adjusted at the base station 100 using local controls or user interfaces (not shown in FIG. 1) or by receiving instructions and commands (i.e., control signals) from the remote devices, including camera 140 and information device 150. The user interface employed at base station 100 is configured to allow user control of all the features and functions described herein, and may be arranged from conventional control and display elements. Such user interface may include menu-driven and graphical user interfaces in some applications. Information device 150 may also include a similar interface in some embodiments of the invention.

As noted above, information device 150 is equipped with a wireless transceiver to facilitate the transmission of wireless control and information signals from information device 150 to base station 100. Accordingly, information device 150 may be advantageously used in some applications to control base station 100 as well as its constituent functional modules including set top box module 120, signal processor 125 and transceiver 110. For example, information device 150 may be used, under the control of the user, to direct the operation of base station 100 remotely to change channels that are displayed on television 130 or information device 150 itself, adjust the volume of the sound system, or control the transmission bit rate of streaming video or audio from the Internet content source.

Such remote control functionality may be particularly useful when it is desirable to include relatively more processing power at the base station 100 than at the remote information device 150. In such situations, the base station 100 may be given, for example, the task of generating the stream displayed on the information device 150 (where multiple windows or sub-windows may be utilized) and the task of determining which windows are given priority for the user's attention and at what times. The transmitted stream from base station 100 would be a composite stream (where the stream uses selected parts of the input signals, as compared to a broader-band multiplexed stream where all of input signals are contained in the transmitted stream). Information device 150 would then be tasked with the relatively less processor intensive job of merely displaying the transmitted stream on the display of information device 150.

An example of remote control functionality includes an arrangement where information device 150 relays information or control signals to other remote devices through base station 100. For example, information device 150 may send a wireless control signal to base station 100 which is then retransmitted to camera 140 to control tilt, pan, and zoom functions of the camera at the designated area (e.g., the baby's room).

Thus, a parent may place the information device 150 in the kitchen to watch television show and receive email messages, while simultaneously preparing dinner and remotely monitoring a sleeping baby. Base station 100 receives a wireless video and audio signal from camera 140 which is located in the designated area, and transmits a signal to information device 150 via wireless link. As noted above, the image of the monitored baby may be constantly displayed on the information device 150 using picture-in-picture, or may be arranged to run in the background.

In the latter situation, the user may configure base station 100 to automatically bring the image of the monitored baby to the front of the display of information device 150, for example, when an unexpected or loud noise (above a threshold which may be defined by the user) is heard by the camera 140 and transmitted to base station 100. At that point, the parent may use information device 150 to send control signals via base station 100 to the camera 140 to pan to the source of the noise (which, for example, is the household cat knocking over the lamp in the room), or zoom the camera to a transmit a larger picture of the baby's face (which, for example, is indicating to the parent that the baby is finished napping).

FIG. 4 depicts an illustrative embodiment of the invention where a base station 400 (having a similar form and functional arrangement to base station 100 including its constituent elements transceiver 110, set-top box module 120 and signal processor 125 shown in FIG. 1 and accompanying description) further incorporates a media player/controller 430 and a radio receiver 440. In accordance with the invention, base station 400 is arranged to interact with remote devices and capture devices, including information device 150 (FIG. 1 and accompanying text) and camera 140 (FIG. 1 and accompanying text), as well as locally coupled devices such as television 130 (FIG. 1 and accompanying text).

Media player/controller 430 and receiver 440 may be incorporated within the same physical enclosure as the other functional modules (i.e., set-top box 420, transceiver 410 and signal processor 425 which have the same features and functions as set-top box module 120, transceiver 110 and signal processor 125 described above). Alternatively, media player/controller 430 and receiver 440 may be physically discrete devices (i.e., separate components) that may be linked to base station 400 using conventional signal and/or control connections, for example, TosLink digital optical connection cables, USB, or standard F-type co-axial or RCA-type video/audio cables.

In instances where media player/controller 430 and receiver 440 are separate components, base station 400 would include appropriate interface connection ports (not shown in FIG. 4), typically on the front or back panel of base station 400. Control connections between base station 400 and media player/controller 430 and receiver 440 may be facilitated using similar connection schemes, or through the use of an RS-232 serial connection or infrared control arrangements such as an IR blaster.

Media player/controller 430 may be selected from a wide variety of devices according to the requirements of the specific application. For example, media player/controller 430 may include VCRs and CD, DVD, MP3, audio cassette, mini-disc, and laser disc players and changers. In addition, media player/controller 430 may include other electronic devices that may typically be a part of home entertainment systems such as surround sound systems, equalizers, signal processors, lighting controllers, and the like. It is noted that while a single media/controller 430 is shown in FIG. 4, a multiplicity of devices may be employed, if desired. That is, base station 400 may incorporate, for example, a CD player and a VCR, and include multiple input ports or connections for an externally coupled MP3 player and DVD player.

Receiver 440 may be selected from a wide variety of devices as well, and includes AM tuners, FM tuners, AM/FM tuners, Internet radio devices, citizen band, weather-band, and HAM radio receivers, emergency frequency (e.g., police, fire, and medical service) scanning devices, and other devices that are capable of receiving broadcast-type signals via wired or wireless sources. It is noted that while a single receiver 440 is shown in FIG. 4, a multiplicity of devices may be employed, if desired. That is, base station 400 may incorporate, for example, a police and fire scanner and a AM/FM tuner, and include multiple input ports or connections for an externally coupled Internet radio device and weather-band radio receiver.

In accordance with the invention, either locally at the base station 400, or remotely from information device 150, media player/controller 430 and receiver 440 may be controlled by the user. In the former case, base station 400 may advantageously function as a single-interface control station for media/player controller 430 and receiver 440 (which, as noted above, may be integrated with base station 400 or be arranged as coupled, but separate, components). Such a single-interface control station may advantageously provide a consistent user interface for all of the coupled devices or integrated modules used in the inventive arrangement. Thus, the user may control a large array of media/player controllers and receivers by using base station 400 acting as a single-interface controller.

The base station 400 of the present invention may be advantageously arranged to assist users in setting up, configuring, operation and programming electronic devices including media player/controller 430 and receiver 440, or other consumer electronic devices.

While such advantages may be realized when such electronic devices are integrated with base station 400, particular advantages are evident when such electronic devices are separate, external components that are supplied by different manufacturers. In such situations, users are typically faced with a sequence of steps to implement a desired feature or function that is unique to each device. For example, the steps to set the clock in a VCR manufactured by Company “A” are typically different than those required to set the clock in a DVD player manufactured by Company “B”. Moreover, the interface itself (typically a remote control) is typically unique to each device. Unfortunately, such remote control devices implement complex set-up, configuration, operation and programming functions using button-dependent schemes. Consumers have often expressed dissatisfaction with the lengthy sequence of button pushes required by conventional devices in order to implement such functions where the sequence is not necessarily intuitive and may require extensive consultation with an operator's manual.

Typical universal remote control devices that are required to “learn” set-up and programming steps from the dedicated remote control, or have limited pre-programming to work with a select number of electronic devices. In both cases, functionality is generally limited to mapping button functions from the dedicated remote to the universal remote control, and no

Set-up, configuration, operation and programming of electronic devices may be facilitated, in accordance with the invention, by using profile data about such electronic devices that is available to base station 400. The profile data consists of device characteristics and/or instructions (such as macros commands) that base station 400 may use to interact with an electronic device in order to implement the desired set-up, configuration, operation, or programming function. Profile data may be stored internally in base station 400, or downloaded from an Internet source or cable service provider head-end controller, for example. The arrangement of the present invention may look up the required profile data related to a large number of electronic devices.

The user is then provided with a simplified and streamlined interface (locally at the base station 400 or remotely at information device 150) where the user implements a macro command to effectuate the desired set-up, configuration, operation or programming function with a single button push or several pushes depending on the application. Advantageously, the single interface provided to the user by the inventive arrangement is device-independent. Thus, for example, a user may program the clock function for both a VCR and DVD player made by different manufacturers by interacting with the base station 400 using the same commands or menu choices (such as “set-clock”) for both electronic devices. Base station 400 would look up the appropriate macro commands (by sending a query to the Internet site or head-end, as noted above) for each electronic device and transmit the commands to the devices to implement the desired function.

The above-described single-interface control functionality may also be implemented using information device 150, in accordance with the invention. In some applications of the invention, therefore, the base station 400 is arranged to accept commands and instructions from information device 150 that are used to set-up, configure, operate or program media player/controller 430 and receiver 440. For example, a user situated in his bedroom operate an AM/FM tuner (as one above-noted example of receiver 440) that is integrated within or coupled to base station 400 which may be located in the living room of the house. Such remote operation could include, for example, selecting a particular station that is heard, or setting a particular station that is programmed as a station pre-set. As noted above, in accordance with the invention, the signal from receiver 440 (that is tuned to the station selected by the user) may be transmitted by base station 400 to a locally coupled home entertainment system (represented by television 130 in FIG. 1), or to information device 150 via wired or wireless links, respectively. Similarly, a user could send a wireless control signal to a CD changer (as one above-noted example of media player/controller 430) to shuffle play select CDs or choose a particular CD or song selection that is played on the locally coupled home entertainment system (represented by television 130 in FIG. 1) or information device 150. As noted above, the same advantages provided by a single-interface for a wide variety of electronic devices are evident when such interface is at the information device 150.

Other features of the invention are contained in the claims that follow.

What is claimed is:

1. A monitoring system using a wireless network, comprising:
a camera for capturing an image of a designated area and having a wireless transmitter for transmitting the captured image signal; and
a base station including
a wireless receiver for receiving the captured image signal,
a set-top module adapted to receive a media signal
a signal processor for processing the captured image signals and received media signals in response to a control signal, and
a wireless transmitter for transmitting the processed signal to a receiving device.

2. The monitoring system of claim 1 wherein the wireless network complies with a standard selected from the group consisting of IEEE-802.11 protocol, IEEE-802.15 protocol, IEEE-802.16 protocol, HomeRF protocol, Bluetooth standard or a variant therein.

3. The monitoring system of claim 1 where the media signal is selected from the group consisting of broadcast television, satellite programming, or Internet content.

4. The monitoring system of claim 1 further including a media player module that is incorporated in the base station.

5. The monitoring system of claim 4 wherein the media player is selected from the group consisting of compact disc players, digital video disc players, laser disc players, radios, cassette tape players, video tape players, MP3 players, mini-disc players, or combinations therein.

6. The monitoring system of claim 1 wherein the base station further includes an input port adapted to receive information and control signals from a media player.

7. The monitoring system of claim 1 further comprising an information device arranged to receive the transmitted signal from the base station.

8. The monitoring system of claim 7 wherein the information device is selected from the group consisting of Internet appliances, mobile phones, personal digital assistants, pagers, cameras, set-top boxes or combinations therein.

9. A method for relaying a digital wireless signal from a transmitter in a first electronic device to a receiver in a second electronic device by a digital wireless interface device, the method comprising the steps of:
receiving the transmitted signal from the first device at a set-top box;
processing the received signal to generate an information signal having a format adapted for use by the second device; and
transmitting the processed signal from the interface device to the second device using a digital wireless signal protocol that is compatible with the receiver in the second device.

10. The method of claim 9 wherein the step of processing processes the received signal into a formatted information signal.

11. The method of claim 10 wherein the format is an MPEG-2 compliant format.

12. The method of claim 9 further including the step of receiving information and control signals from the second device so as to control the step of processing.

13. A base station in a wireless network, comprising:
a wireless receiver arranged to receive wireless information and control signals;
a wireless transmitter arranged to transmit a multiplexed signal;
a set-top box module arranged to receive media content;
a controller operatively coupled to the wireless transmitter, wireless receiver and set-top box module for selectively controlling the multiplexing of the information, control and media content into the transmitted signal.

14. The base station of claim 13 further including an input for receiving electronic media signals from an electronic device.

15. The base station of claim 14 where the controller is arranged to accept wireless control signals from a remote control device to selectively multiplex the received electronic media signals into the transmitted signal.

16. The base station of claim 14 wherein the electronic device is selected from the group consisting of compact disc players, digital video disc players, laser disc players, radios, cassette tape players, video tape players, MP3 players, mini-disc players, or combinations therein.

17. A network interface device, comprising:
a WAN interface for receiving a broadband signal from a WAN;
a digital wireless interface for receiving digital wireless signals from a remote digital wireless device;
a signal processor for generating a processed signal from the received signals;
a digital wireless transmitter for transmitting the processed signal to one or more remote digital wireless devices.

18. The network interface device of claim 17 further including a set-top box for receiving a broadcast signal from a head-end.

19. The network interface device of claim 17 wherein the processor includes an input for receiving control signals from the remote digital wireless devices.

20. The network interface device of claim 19 further including an output port for transmitting configuration information to coupled electronic devices in response to the received control signals.
